(19) United States
(12) Patent Application Publication
(10) Pub. No.: US 2025/0233322 A1
(43) Pub. Date: Jul. 17, 2025

(54) ANTENNA STRUCTURE AND ARRAY ANTENNA STRUCTURE

(71) Applicant: Panasonic Intellectual Property Management Co., Ltd., Osaka (JP)

(72) Inventors: NORIHITO TSUKAHARA, Kyoto (JP); MASATO MORI, Hyogo (JP); TAKAYUKI SOTOYAMA, Kanagawa (JP); NAOKI ADACHI, Kanagawa (JP)

(21) Appl. No.: 19/096,799

(22) Filed: Apr. 1, 2025

Related U.S. Application Data
(63) Continuation of application No. PCT/JP2023/033556, filed on Sep. 14, 2023.

(30) Foreign Application Priority Data
Oct. 12, 2022 (JP) 2022-164167

(51) Int. Cl. H01Q 21/06

(52) U.S. Cl. CPC H01Q 21/065

(57) ABSTRACT

An antenna structure including: an antenna board that includes two or more patch antenna elements arranged at an interval P along an X direction, and that is disposed along an XY plane; a power supply control board that is disposed along an XZ plane; and a connection member that includes an insulating resin extending in an X direction, and a plurality of joining electrodes provided over a surface of the insulating resin, the connection member connecting the antenna board to the power supply control board, in which the connection member includes a plurality of projections having insulating properties disposed apart from each other in the X direction, the plurality of projections includes a plurality of protruding insulating portions, respectively, each of the plurality of protruding insulating portions protruding from the connection member in the Z direction and the Y direction, with a space between adjacent protruding insulating portions among the plurality of protruding insulating portions, and each of the joining electrodes of the connection member is formed on the XY plane and the XZ plane of a corresponding one of the plurality of protruding insulating portions of the projections.

### TECHNICAL FIELD

The present disclosure relates to an antenna structure and an array antenna structure.

### BACKGROUND ART

In recent years, commercial services using fifth generation (5G) mobile communication systems have started, and 5G systems are expected to further accelerate sophistication of multimedia services and provide new value as an infrastructure technology that supports industries or society.

5G is a mobile communication system that handles a high frequency band higher than 10 GHz, such as millimeter waves. As transmission and reception antennas of such systems, patch antennas (microstrip antennas) are generally used. A patch antenna is a type of planar antenna including, as components thereof, a dielectric substrate including, on respective surfaces thereof, radiation elements that are formed as wiring, and a ground conductor plate.

In order to achieve an intended radiation directionality (radiation pattern), a multi-element array antenna including a plurality of patch antennas that are regularly arranged in a straight line or a plane is often used.

Use of such a multi-element array antenna also enables large-capacity communication.

Antenna elements, such as patch antennas, form an antenna structure (that is, antenna module) by being connected to various types of signal processing circuits or power feeding circuits.

Such an antenna structure is then housed in a housing, such as a case or a cover, and is put into practical use as an antenna unit for communication.

For example, PTL 1 discloses an antenna structure and an antenna unit including an antenna element part and a circuit part that amplifies an electric signal converted by the antenna element part.

The antenna element part and the circuit part are configured as separate bodies, and together form an antenna unit by being connected to each other by a cable and housed in an external case in a manner disposed side by side.

In recent years, there is a strong demand for smaller antenna units, because large antenna units impose limitations on the place for installing the antennas.

However, in the structure of an antenna structure in which the antenna element part and the circuit part are disposed side by side, as disclosed in PTL 1, because the area for disposing the antenna element part and the circuit part side by side is required in a planar direction, it is difficult to achieve a size reduction.

In order to reduce the size of an antenna unit, for example, PTL 2 discloses an antenna structure including a ground conductor, an antenna element part, and a circuit part, in which the antenna element part is provided as an antenna pattern formed on the top surface of the ground conductor, with a first dielectric substrate interposed therebetween; the circuit part includes a circuit pattern that is formed on the bottom surface of the ground conductor, with a second dielectric substrate interposed therebetween, and circuit components that are implemented on the circuit pattern.

### CITATION LIST

### Patent Literature

PTL 1: Unexamined Japanese Utility Model Publication No. H06-041220
PTL 2: Unexamined Japanese Patent Publication No. H06-152237

### SUMMARY OF THE INVENTION

An antenna structure according to one aspect of the present disclosure includes: an antenna board that includes two or more patch antenna elements arranged at an interval P along an X direction, the antenna board being disposed along an XY plane; a power supply control board that is disposed along an XZ plane; and a connection member that includes an insulating resin extending in an X direction, and a plurality of joining electrodes provided over a surface of the insulating resin, the connection member connecting the antenna board to the power supply control board, in which the connection member includes a plurality of projections having insulating properties disposed apart from each other in the X direction, the plurality of projections includes a plurality of protruding insulating portions protruding from the connection member in a Z direction and a Y direction, with a space between adjacent protruding insulating portions among the plurality of protruding insulation portions, and each of the plurality of joining electrodes of the connection member is formed on the XY plane and the XZ plane of a corresponding one of the plurality of protruding insulating portions of the projections.

### BRIEF DESCRIPTION OF THE DRAWINGS

FIG. 1A is a schematic diagram illustrating an example of an antenna structure according to an exemplary embodiment.

FIG. 1B is a schematic diagram of a cross section of the antenna structure according to the exemplary embodiment illustrated in FIG. 1A, taken along line E-E′, in a view from a near side to a far side in an X direction.

FIG. 2 is a schematic diagram illustrating an example of an array antenna structure according to the exemplary embodiment.

FIG. 3A is a schematic diagram illustrating an example of a joining member according to the exemplary embodiment.

FIG. 3B is a schematic diagram of an example of the joining member according to the exemplary embodiment illustrated in FIG. 3A, in a view from the near side to the far side in a Y direction.

FIG. 3C is a schematic diagram of an example of the joining member according to the exemplary embodiment in FIG. 3A, in a view from a right side to a left side in the X direction.

FIG. 4A is a schematic diagram illustrating an example of a structure with the joining member joined to an antenna board according to the exemplary embodiment.

FIG. 4B is a schematic diagram of an example of the structure with the joining member joined to the antenna board according to the exemplary embodiment, in a view from the right side to the left side in the X direction.

FIG. 5 is a schematic diagram of an example of a structure with the joining member joined to a power supply control board according to the exemplary embodiment in a view from the right side to the left side in the X direction.

FIG. 6A is a schematic diagram illustrating an example of a prototype joining member.

FIG. 6B is a schematic diagram of an example of the prototype joining member in a view from the near side to the far side in the Y direction.

FIG. 6C is a schematic diagram of an example of the prototype joining member in a view from the right side to left far side in the X direction.

FIG. 7 is a schematic diagram illustrating an example of a structure with the prototype joining member joined to an antenna board.

### DESCRIPTION OF EMBODIMENT

In the antenna structure disclosed in PTL 2, even if the antenna element is reduced in size, the overall size of the antenna structure is determined by the area where the circuit components are mounted on the surface of the dielectric substrate, on the opposite side of the surface provided with the antenna element part. Therefore, it has been a challenge to achieve an antenna structure smaller than or equal to the area for mounting the circuit components.

Furthermore, even in a case where an array antenna structure is formed by arranging a plurality of the antenna elements, because the interval at which the antenna elements are arranged is restricted by the area for mounting the circuit components, which are mounted on the dielectric substrate on the opposite side of the surface on which the antenna element part is disposed, it is difficult to achieve an array antenna structure in which a plurality of small antenna elements are arranged adjacently each other at a narrow pitch.

Furthermore, in such an array antenna structure, the antenna elements are usually arranged at an interval of a half wavelength of the communication frequency. However, for example, in a case where high-frequency communication, such as that at 39 GHz is demanded, the half wavelength of such a wavelength becomes 2.56 mm, which is extremely small. Therefore, it is even more challenging, with the structure of the antenna structure disclosed in PTL2, to arrange a plurality of antenna elements at a half wavelength of the communication wavelength.

As described above, an object of the present disclosure is to provide a small and high-quality antenna structure and array antenna structure that are capable of supporting high frequency communication, without any size restriction imposed by the size or the area for implementing circuit components of a signal circuit or a power feed circuit.

Before describing the exemplary embodiment of the present disclosure in detail with reference to the drawings, various aspects of the present disclosure will now be described.

An antenna structure according to a first aspect includes: an antenna board that includes two or more n patch antenna elements arranged at an interval P along an X direction, the antenna board being disposed along an XY plane; a power supply control board that is disposed on an XZ plane; and a connection member that includes an insulating resin extending in an X direction, and a joining electrode that is provided on a surface of the insulating resin, the connection member connecting the antenna board and the power supply control board, in which the connection member includes a plurality of projections having insulating properties disposed apart from each other in the X direction, each of the plurality projections includes a protruding insulating portion protruding from the connection member in each of a Z direction and a Y direction, with a space between adjacent protruding insulating portions, and the joining electrode of the connection member is formed on the XY plane and the XZ plane of each of the protruding insulating portions of the projections.

In an antenna structure according to a second aspect, in the first aspect, the interval P is a half wavelength of a communication frequency.

In an antenna structure according to a third aspect, in the second aspect, a height T and a height S of the protruding insulating portion of the projection in the Z direction and the Y direction, respectively, are both 0.05 mm or more.

An array antenna structure according to a fourth aspect includes: two or more m antenna structures according to any one of the first to third, the two or more m antenna structures being arranged on an XY plane.

In the array antenna structure according to the fifth aspect, in the fourth aspect, the patch antenna elements of two adjacent antenna structures are arranged at an interval Q in the Y direction.

In the array antenna structure according to the sixth aspect, in the fifth aspect, the interval Q is a half wavelength of a communication frequency.

With the antenna structure and the array antenna structure according to the aspect of the present disclosure, it is possible to provide antenna structure and array antenna structure without any size restriction, due to the size or the area for mounting the circuit components of the signal circuit or the power feed circuit. In addition, because protruding insulating portions can ensure a large creepage distance between adjacent joining electrodes, it is possible to provide small and high-quality antenna structure and array antenna structure capable of supporting high-frequency communication without any quality defects, such as soldering defects.

An antenna structure and an array antenna structure according to an exemplary embodiment of the present disclosure will now be described with reference to the drawings.

Note that, in the drawings, substantially the same members are denoted by the same reference numerals.

### Exemplary Embodiment

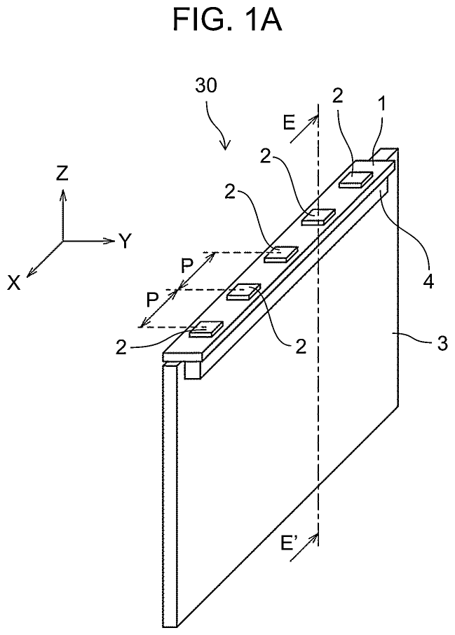

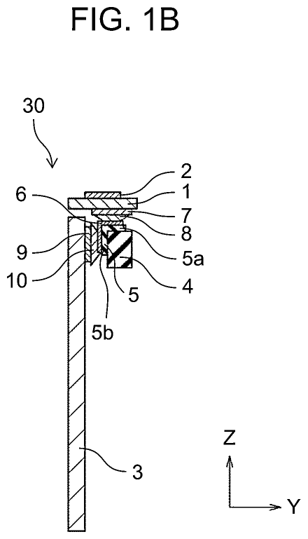

Antenna structure 30 according to an exemplary embodiment will now be described with reference to FIGS. 1A to 1B. Antenna structure 30 includes antenna board 1 and power supply control board 3 that are connected via connection member 4. The three XYZ directions are orthogonal to one another.

FIG. 1A is a schematic diagram illustrating an example of antenna structure 30 according to the exemplary embodiment.

In FIG. 1A, antenna board 1 is positioned in parallel with the XY plane. On the surface of antenna board 1, n patch antenna elements 2 are arranged at an equal interval P, in parallel with the X direction.

Interval P between patch antenna elements 2 is determined by the communication frequency of the device, and is generally set to a value of a half the wavelength. In the present exemplary embodiment, as an example, because the communication frequency is 39 GHz, interval P is set to 2.56 mm corresponding to a half wavelength.

In the present exemplary embodiment, as an example, antenna board 1 is fabricated to have a width of 3 mm, a length of 20 mm, and a thickness of 0.8 mm, from a multilayer circuit board material “MEGTRON 7” manufactured by Panasonic Corporation as a base material.

As an example, five patch antenna elements 2, each having a size of 2 mm×2 mm and made from a copper foil having a thickness of 18 μm, are arranged at equal interval P.

Any optimum number (n) of patch antenna elements 2 may be fabricated, depending on the application of the antenna. Here, n is an integer satisfying n>0.

The material of antenna board 1 is not limited to “MEGTRON 7”, and may be any other glass epoxy material or ceramic material.

Antenna board 1 and power supply control board 3 are connected via connection member 4 that is made of an insulating resin and that extends in the X direction.

Connection member 4 having a width of 1.0 mm in the Y direction, a height of 2.0 mm in the Z direction, and a length of 20 mm in the X direction is used, as an example.

As a material as the insulating resin forming connection member 4, liquid crystal polymer (LCP) having a dielectric constant of 4.3 and a dielectric loss tangent of 0.015 is used as an example, but the material may also be PPA, ABS, PEEK, or PC, without limitation to LCP.

On power supply control board 3, circuit components of the signal circuit or the power feed circuit are mounted, although not illustrated in the drawings. In the present exemplary embodiment, as an example, the size of power supply control board 3 is set to a length of 50 mm in the X direction, a length of 30 mm in the Z direction, and a thickness of 1.6 mm in the Y direction.

Achieved with the configuration described above is antenna structure 30 in which antenna board 1 disposed in parallel with the XY plane and power supply control board 3 disposed in parallel with the XZ plane are electrically connected by connection member 4.

FIG. 1B is a schematic diagram of a cross section of antenna structure 30 illustrated in FIG. 1A, taken along line E-E′, in a view along the X direction from a near side to a far side. As illustrated in FIG. 1B, connection member 4, which is made of an insulating resin, is provided with projection 5 that includes protruding insulating portions 5a, 5b for increasing a creepage distance, as will be described later, on the XY plane and the XZ plane, respectively. On the XY plane of protruding insulating portion 5a and the XZ plane of protruding insulating portion 5b of each projection 5, joining electrode 6 is provided.

Joining electrode 6 is provided to the XY plane of protruding insulating portion 5a of projection 5 provided to connection member 4. On antenna board 1, power feed electrode 7 is provided on the opposite side of the surface provided with patch antenna elements 2. Joining electrode 6 forms first joined portion 8 by being metal-joined to power feed electrode 7.

Joining electrode 6 is provided to the XZ plane of protruding insulating portion 5b of projection 5 provided to connection member 4. By being metal-joined to power feed electrode 9 provided on power supply control board 3, joining electrode 6 forms second joined portion 10.

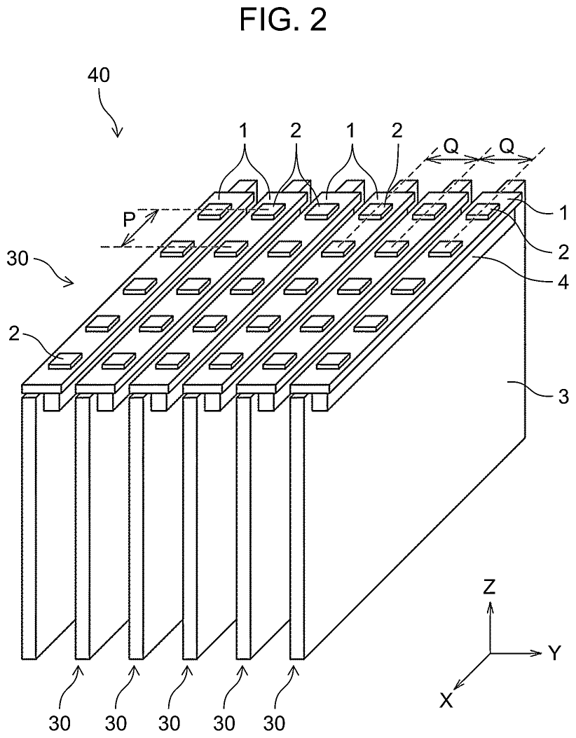

Array antenna structure 40 according to the exemplary embodiment will now be described with reference to FIG. 2.

As illustrated in FIG. 2, array antenna structure 40 includes m antenna structures 30 that are arranged along the Y direction of the XY plane. Here, m is an integer of two or more.

In the present exemplary embodiment, m=6 antenna structures 30 are arranged along the Y direction.

Interval Q between patch antenna elements 2 of two adjacent antenna structures 30 in the Y direction is determined by the communication frequency of the device, and is set to a value of a half the wavelength. In the present exemplary embodiment, as an example, because the communication frequency is 39 GHz, interval Q is set to 2.56 mm corresponding to a half wavelength.

Furthermore, any optimum number (m) of antenna structures 30 may be arranged, depending on the application of the antenna.

Achieved with the configuration described above is a small array antenna structure 40 in which n×m patch antenna elements 2 are arranged in a matrix, on XY plane, at an equal interval that is a half the wavelength of a communication frequency. Note that antenna boards 1 included in adjacent respective antenna structures 30 may be in contact with each other, or may be kept away from each other without being in contact.

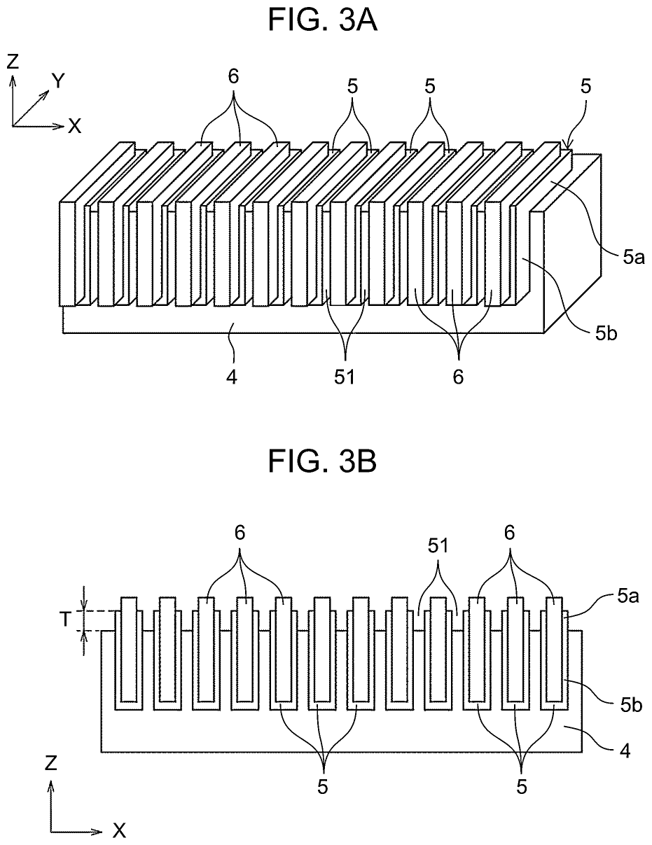

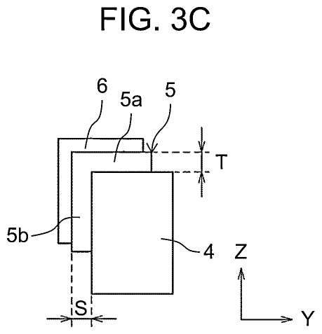

A more specific configuration of connection member 4 according to the exemplary embodiment will now be described with reference to FIGS. 3A to 3C.

As illustrated in FIGS. 3A to 3C, connection member 4 has a rectangular parallelepiped shape, and is made of an insulating resin. Connection member 4, which has a rectangular parallelepiped shape and made of an insulating resin, includes a plurality of projections 5 each of which has a thin L-shaped plate-like shape, that is insulating, and that are arranged in a manner spaced apart from one another in the X direction. As an example, the plurality of projections 5 are disposed upright and in parallel with each other, at equal intervals, in a comb-like shape. Each projection 5 includes protruding insulating portions 5a, 5b protruding in the Z direction and the Y direction, respectively, from connection member 4. Between adjacent protruding insulating portions 5a, 5b, space 51 is ensured.

That is, protruding insulating portions 5a of projection 5 having height T are provided on the XY plane of connection member 4. Protruding insulating portions 5b of projection 5 having height S are provided on the XZ plane. Furthermore, on the XY plane of protruding insulating portion 5a and the XZ plane of protruding insulating portion 5b of each projection 5, joining electrode 6 is provided.

In the present exemplary embodiment, as an example, heights T and S are set to T=S=0.1 mm. In order to ensure a long creepage distance between adjacent joining electrodes 6, it is preferable for such heights T and S to be set to 0.05 mm or more, considering the joining quality with respect to antenna board 1 or power supply control board 3, which will be described later.

In the present exemplary embodiment, as an example, the same insulating resin as connection member 4 is used as the material of projection 5, but the material is not limited thereto, and projection 5 may be made of an insulating resin different from joining member 4.

As an example, joining electrode 6 is formed as an electrode including plating of Cu having a thickness of 10 μm, and Ni having a thickness of 0.2 μm, and Au having a thickness of 0.05 μm; however, joining electrode 6 may also be formed by conductive resin printing, by dispensing coating, or using any other method, for example.

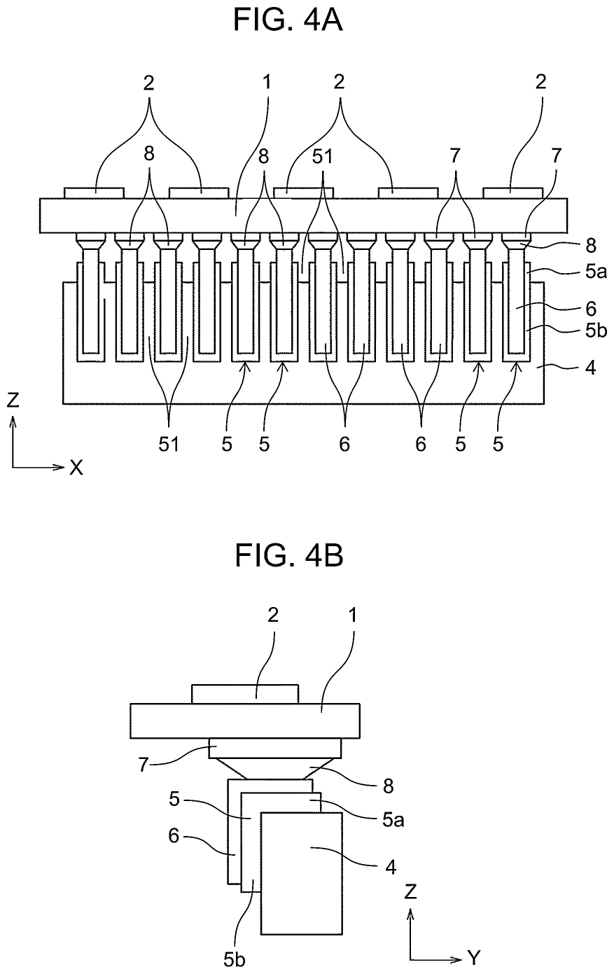

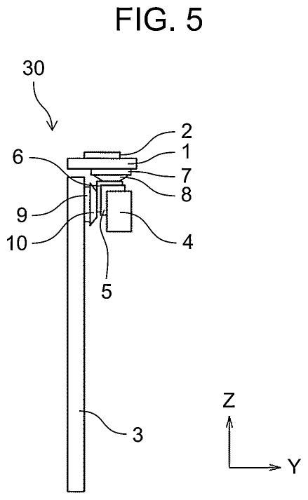

A specific structure for joining antenna board 1 and power supply control board 3 via connection member 4 according to the exemplary embodiment will now be described with reference to FIGS. 4A to 4B and 5.

As illustrated in FIGS. 4A to 4B, power feed electrode 7 forms first joined portion 8, by being metal-joined to joining electrode 6 provided on the XY plane of protruding insulating portion 5a of projection 5 that is provided on connection member 4.

In the present exemplary embodiment, as an example, solder having a composition of Sn-3.0Ag-0.5Cu is used as a material for metal-joining joining electrode 6 to power feed electrode 7.

The joining material is not limited to solder, and a conductive paste made of Ag or Cu or any other joining material may be used.

Joining electrodes 6 are provided to protruding insulating portions 5a of respective projections 5 on connection member 4, protruding insulating portions 5a protruding from connection member 4, with space 51 between adjacent protruding insulating portions 5a. Therefore, it is possible to ensure a long creepage distance between adjacent joining electrodes 6. In addition, high-quality joined portion can be achieved without any quality defects, such as solder bridge, even when used in joining are narrowly adjacent joining electrodes, as required in antennas for supporting high-speed communication.

Joining electrodes 6 are also provided on the XZ plane of protruding insulating portions 5b of respective projections 5 provided to connection member 4, as illustrated in FIG. 5. Antenna structure 30 is achieved by forming second joined portion 10, by metal-joining joining electrodes 6 to power feed electrode 9 provided on power supply control board 3.

In the present exemplary embodiment, Sn—Bi solder is used, as an example, to join power feed electrode 9 to joining electrode 6, but the present invention is not limited thereto.

In addition, first joined portion 8 and second joined portion 10 may sometimes become integrated with each other, depending on a molten state of the solder or the like that is a material for metal joining.

Joining electrodes 6 are provided to protruding insulating portions 5b of respective projections 5 on connection member 4, protruding insulating portions 5b protruding from connection member 4, with space 51 between adjacent protruding insulating portions 5b. Therefore, it is possible to ensure a long creepage distance between adjacent joining electrodes 6. In addition, high-quality joined portion can be achieved without any quality defects, such as solder bridge, even when used in joining are narrowly adjacent joining electrodes, as required in antennas for supporting high-speed communication.

With such a configuration, it is possible to provide small antenna structure 30 and array antenna structure 40, without being restricted in size, by the size or the area for implementing circuit components of a signal circuit or a power feed circuit. In addition, because protruding insulating portions 5a, 5b can ensure a large creepage distance between adjacent joining electrodes 6, it is possible to provide small and high-quality antenna structure 30 and array antenna structure 40 capable of supporting high-frequency communication without any quality defects, such as soldering defects.

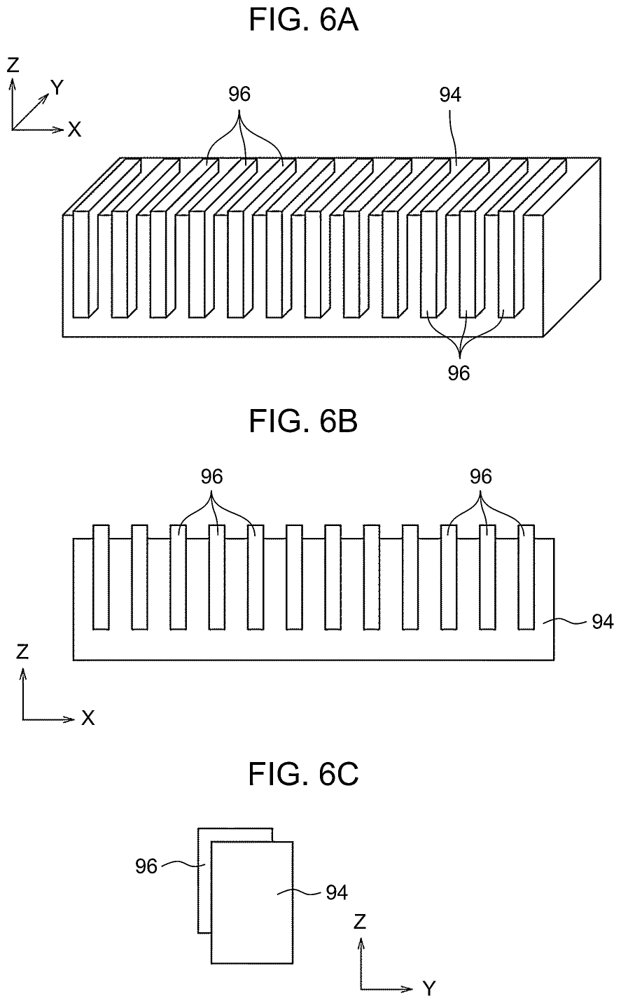

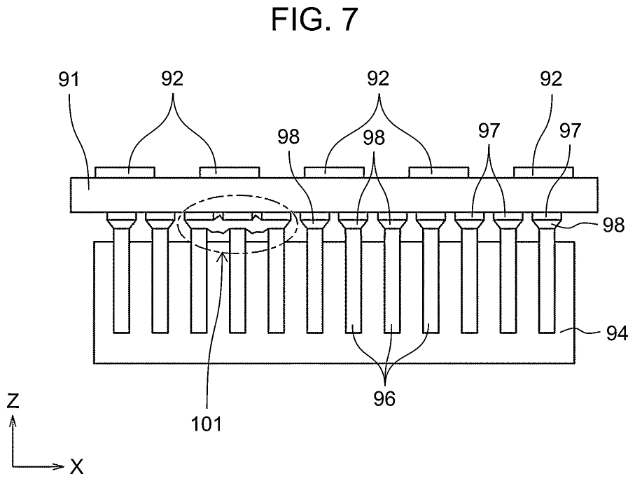

Next, a problem experienced by joining antenna board 91 and power supply control board via prototype connection member 94 having a simple rectangular parallelepiped shape, with no projections, will be specifically described, with reference to FIGS. 6A to 6C, and 7 illustrating a prototype made prior to the completion of the present disclosure.

As illustrated in FIGS. 6A to 6C, in prototype connection member 94, joining electrodes 96 are provided on the XY plane and the XZ plane that are on the same planes as the XY plane and the XZ plane of connection member 94, without protruding from connection member 94.

When such a configuration, when narrowly adjacent joining electrodes 96, which are required in antennas for supporting high-frequency communication, are metal-joined to power feed electrode 97 of the antenna board 91 having patch antenna elements 92, because only small creepage distance is ensured between adjacent joining electrodes 96, as illustrated in FIG. 7, joining bridge 101 cannot be avoided.

By contrast, in the exemplary embodiment of the present disclosure, with protruding insulating portions 5a, 5b protruding from connection member 4 toward a target to be joined and facing each other with space 51 therebetween, a large creepage distance can be ensured between adjacent joining electrodes 6. Therefore, narrowly adjacent electrodes required in antennas for supporting high-frequency communication can be joined with high quality without any quality defects, such as joining bridge. Hence, it is possible to manufacture and to provide small and high-quality array antenna structure 40 capable of having a structure in which patch antenna elements 2 are arranged in a matrix, at an equal interval at a half wavelength of the communication frequency.

With the antenna structure and the array antenna structure according to the above exemplary embodiment of the present disclosure, it is possible to provide small antenna structure 30 and array antenna structure 40 supporting high-frequency communication without any size restriction, due to the size or the area for mounting the circuit components of the signal circuit or the power feed circuit. Moreover, it is possible to provide high-quality antenna structure 30 and array antenna structure 40 without any quality defects, such as soldering defects.

In other words, by setting the interval at which patch antenna elements 2 are arranged, that is, the direction of the thickness of or the direction in which antenna structures 30 are arranged in a manner intersecting with, e.g., orthogonally to the direction that is affected by the sizes of circuit components or the area where the circuit components are mounted, it is possible to prevent such a direction from being affected by the mounting area or the like.

Specifically, because the area in which the circuit components are mounted extends along the XZ plane and is orthogonal to the Y direction which is the thickness direction corresponding the overall size of antenna structure 30, it is possible to achieve small antenna structure 30 equal to or smaller than the area where the circuit components are mounted in the thickness direction, without the thickness direction being affected by the mounting area or the like.

Furthermore, the area in which the circuit components are mounted extends along the XZ plane, and is orthogonal to the Y direction that is the direction in which the antenna structures 30 are arranged. Therefore, the arranging direction is not affected by the mounting area or the like. Even in a configuration in which array antenna structure 40 includes an arrangement of a plurality of patch antenna elements 2, the interval between patch antenna elements 2 are arranged is not restricted by the area in which the circuit components are mounted or the like. Therefore, it is possible to achieve array antenna structure 40 including a plurality of small patch antenna elements 2 that are narrowly adjacently arranged.

Furthermore, in a configuration in which patch antenna elements 2 are arranged at intervals of a half the wavelength of the communication frequency, e.g., in which high frequency communication such as 39 GHz is required, that is, even when the value of the half wavelength of the wavelength is extremely small, it is possible to arrange a plurality of patch antenna elements at the half wavelength of the wavelength.

Note that, by combining any of the exemplary embodiments and modifications thereof described above as appropriate, it is possible to achieve the respective effects thereof. Combination of exemplary embodiments, combination of examples, or combination of exemplary embodiments with examples are possible, and combination of features in different exemplary embodiments or examples are also possible.

### INDUSTRIAL APPLICABILITY

With the antenna structure and the array antenna structure according to the aspect of the present disclosure, it is possible to provide high-quality small antenna structure and array antenna structure supporting high-frequency communication without any size restriction, due to the size or the area for mounting the circuit components of the signal circuit or the power feed circuit.

### REFERENCE MARKS IN THE DRAWINGS

1 antenna board
2 patch antenna element
3 power supply control board
4 connection member
5 projection
5a protruding insulating portion
5b protruding insulating portion
6 joining electrode
7 power feed electrode
8 first joined portion
9 power feed electrode
10 second joined portion
30 antenna structure
40 array antenna structure
51 space
91 antenna board
92 patch antenna element
94 connection member
96 joining electrode
97 power feed electrode
101 joining bridge

1. An antenna structure comprising:
an antenna board that includes two or more patch antenna elements arranged at an interval P along an X direction, the antenna board being disposed along an XY plane;
a power supply control board that is disposed along an XZ plane; and
a connection member that includes an insulating resin extending in an X direction, and a plurality of joining electrodes provided over a surface of the insulating resin, the connection member connecting the antenna board to the power supply control board,
wherein the connection member includes a plurality of projections having insulating properties disposed apart from each other in the X direction,
the plurality of projections includes a plurality of protruding insulating portions, respectively,
each of the plurality of protruding insulating portions protruding from the connection member in a Z direction and a Y direction, with a space between adjacent protruding insulating portions among the plurality of protruding insulating portions, and
each of the plurality of joining electrodes of the connection member is formed on the XY plane and the XZ plane of a corresponding one of the plurality of protruding insulating portions of the projections.

2. The antenna structure according to claim 1, wherein the interval P is a half wavelength of a communication frequency.

3. The antenna structure according to claim 2, wherein a height T and a height S of the protruding insulating portion of the projection in the Z direction and the Y direction, respectively, are both 0.05 mm or more.

4. An array antenna structure comprising two or more antenna structures each being the array antenna structure according to claim 1, the two or more antenna structures being arranged on an XY plane.

5. The array antenna structure according to claim 4, wherein two adjacent patch antenna elements each included in a corresponding one of two adjacent antenna structures among the antenna structures are arranged at an interval Q in the Y direction.

6. The array antenna structure according to claim 5, wherein the interval Q is a half wavelength of a communication frequency.
